(19) United States
(12) Patent Application Publication
(10) Pub. No.: US 2024/0376748 A1
(43) Pub. Date: Nov. 14, 2024

(54) Vehicle key housing with concealable window breaker

(71) Applicant: Guangzhou NiuGuanjia Technology Co., Ltd., Guangzhou (CN)

(72) Inventor: Jiexue LIN, Guangzhou (CN)

(21) Appl. No.: 18/659,268

(22) Filed: May 9, 2024

(30) Foreign Application Priority Data
May 12, 2023 (CN) 202321149600.5

(51) Int. Cl. E05B 19/00; A62B 3/00

(52) U.S. Cl. CPC E05B 19/00; A62B 3/00

(57) ABSTRACT

A vehicle key housing with a concealable emergency window breaker includes a key housing body which is in a rigid structure entirely or at least partially. The rigid structure forms an accommodating cavity with an opening facing the edge of the key housing body. An emergency window breaker is further included, having a folded state and a use state. In the use state, a window breaking tip of the window breaker protrudes from the opening and extends beyond the edge of the key housing body, and in this state, the rigid structure of the key housing body provides support for the window breaker. In the folded state, the window breaker is folded within the accommodating cavity, with the window breaking tip not extending beyond the edge of the key housing body.

### CROSS REFERENCE TO RELATED APPLICATIONS

The present application claims priorities from Chinese Application No. CN 202321149600.5 filed on May 12, 2023, all of which are hereby incorporated herein by reference.

### TECHNICAL FIELD

The present disclosure relates to the field of vehicle keys, and more particularly to a vehicle key housing with a concealable window breaker.

### BACKGROUND

In daily life, in order to ensure the safety of passengers, safety hammers are often equipped near the glass windows on vehicles, such as buses. However, safety hammers are not user-friendly for users such as the elderly, the pregnant, and children. Additionally, the use of safety hammers requires a relatively large operating space, which compromises safety performance. In this context, automatic window breakers have emerged. Automatic window breakers amplify the brittleness and toughness of tempered glass materials. The striker of the automatic window breaker reduces the contact area to increase the pressure applied to the glass. Upon triggering of the trigger mechanism, a large amount of impulse is applied to the tempered glass in an extremely short period of time. Moreover, the window frame significantly constrains the tempered glass, limiting its elastic deformation and further improving the window breaking efficiency. Users only need to strike a corner of the vehicle window with the automatic window breaker, expanding the use scenarios.

However, in existing technologies, most automatic window breakers have a relatively large volume, which adversely affects their flexibility and portability, and exposes a risk of detachment, causing secondary injury to the vehicle occupants. Additionally, automatic window breakers mostly have only a single window breaking function with low frequency of use. In emergency situations, drivers may have difficulty recalling the exact location of the automatic window breaker, which increases safety hazards. Therefore, how to overcome the problem of the large volume of automatic window breakers and address the safety hazard caused by drivers' unfamiliarity with the window breaker is an urgent issue to be solved in this field.

### SUMMARY

The present disclosure provides a vehicle key housing with a concealable window breaker to address the problems of the large volume of window breakers and the safety hazard caused by drivers' unfamiliarity with the window breaker.

A vehicle key housing with a concealable window breaker according to the present disclosure includes a key housing body, wherein the key housing body is in a rigid structure entirely or at least partially, and the rigid structure forms an accommodating cavity with an opening facing the edge of the key housing body. The key housing further includes a window breaker having a folded state and a use state. In the use state, the window breaking tip of the window breaker protrudes from the opening and extends beyond the edge of the key housing body, and in this state, the rigid structure of the key housing body provides support for the window breaker. In the folded state, the window breaker is folded within the accommodating cavity, and the window breaking tip does not extend beyond the edge of the key housing body. This design advantageously utilizes the rigid structure of the key housing body to provide stable support for the window breaker in the use state, while the accommodating cavity provides an isolation shield for the window breaker in the folded state, preventing the window breaker from scratching the human body or other components.

According to an embodiment of the present invention, the key housing body as a whole forms a grip structure with a long axis direction and a short axis direction, the grip structure having two ends along the long axis direction, the dimension of one end of the key housing body at the short axis direction is smaller than that at another end. The accommodating cavity is located at the one end with smaller dimension, and the opening faces the edge of that end. This design beneficially enhances the identifiability of the key housing body by creating a noticeable size difference between the two ends, reducing the likelihood of misoperation by the user and shortening the user's reaction time in emergency window breaking situations. Additionally, the long and short axis design facilitates hand gripping, guiding the user's force application during window breaking and improving the window breaking efficiency. Furthermore, the accommodating cavity in the key housing body reduces the volume of the window breaker, and the organic combination of the window breaker and the key housing body enhances the portability of the window breaker and increases the versatility of the key housing.

Particularly, the outer surface of the key housing body is a curved transitional surface or a combination of multiple curved transitional surfaces to facilitate hand gripping. This design beneficially improves the fit between the user's fingers and the key housing body, enhancing grip comfort. It also enhances the aesthetic appeal of the key housing body, prolonging the time the user sees the key housing and shortening the time needed to locate the window breaker.

According to an embodiment of the present invention, the accommodating cavity protrudes from the surface of the key housing body, forming a straight end surface on the side opposite the opening. This design allows the window breaking tip to protrude from the opening, while the straight end surface provides a support surface for compressing an elastic mechanism of the window breaker, facilitating the switching between the use state and the folded state of the window breaker.

According to an embodiment of the present invention, the key housing body includes an upper housing and a lower housing in a mating structure, wherein the accommodating cavity is integrally formed with the lower housing as a metal structure, and the lower housing is provided on the inner side thereof with a cover plate to enclose the accommodating cavity. This design beneficially enhances the strength of the accommodating cavity by using an integrally formed metal structure, thereby improving the stability of the window breaker. It is advantageous to increase the stability of the key housing body through the mating structure, thereby providing strong support for the window breaker. It is advantageous to limit the volume of the window breaker through the cover plate, thereby increasing the potential energy stored in the elastic mechanism within the window breaker.

The upper housing may be also in a metal structure, and the upper housing, lower housing, and accommodating cavity together form the rigid structure. The upper and lower housings are secured together with connectors, such as screws, into an integrated structure. A button access window is provided in the middle of the upper housing, and a weight reduction window is provided in the middle of the lower housing. This design effectively reduces the weight increase of the key housing caused by the addition of the window breaker, enhancing the flexibility and portability of the key housing.

The key housing body may further include a middle housing sandwiched between the upper housing and the lower housing, wherein the middle housing is made of a flexible material, forming an annular flexible surface along the mating area of the upper and lower housings. This design provides a flexible contact surface for a rigid structure to enhance the tightness of the key shell, prolonging the service life of the key housing and window breaker. Additionally, the annular flexible surface increases friction when contacted by the user, preventing detachment of the window breaker during use and improving safety.

According to an embodiment of the present invention, the accommodating cavity has an axial internal space with dimensions larger than the entire window breaker. The opening is formed at the front end of the axial internal space, and the rear end is closed. An elastic mechanism is arranged between the rear end and the window breaker, supporting the window breaker and causing the window breaking tip to protrude from the opening. This design beneficially confines the volume and position of the window breaker within the axial internal space and limits the direction of the window breaking force through the front opening and rear closed end. The elastic mechanism stores potential energy for the window breaker, enhancing the versatility and portability of the key housing.

In particular, the window breaker includes a sliding cylinder, a limiting cylinder, and an actuation handle. The window breaking tip is formed at the front end of the sliding cylinder, and the limiting cylinder, with a larger diameter than the sliding cylinder, is coaxially arranged at the rear end of the sliding cylinder. The actuation handle is connected to the side of the limiting cylinder and extends radially. A sliding groove is formed on the accommodating cavity, and the actuation handle slides within the sliding groove to switch the window breaker between the folded state and the use state. This design beneficially enables the window breaking tip to extend and retract through the sliding motion of the sliding cylinder, the limiting cylinder prevents excessive movement of the window breaking tip, and the actuation handle provides a simple force application point for the user.

Additionally or alternatively, the sliding groove has an overall Z-shape, including an upper horizontal groove, a connecting groove, and a lower horizontal groove. A limiting recess for engaging the actuation handle is provided at the end of the upper horizontal groove away from the window breaking tip. A protruding reset flange is arranged at the rear end of the limiting cylinder. The accommodating cavity is provided with a front support and a rear support, with the front support having a supporting aperture for the sliding motion of the sliding cylinder, and the rear support having a reset aperture for engaging the reset flange. This design beneficially facilitates the switching between the use state and the folded state of the window breaker through the Z-shaped sliding groove, enhancing the versatility and portability of the key housing.

Compared to existing technologies, the present disclosure integrates the window breaker and the key housing, which can reduce the volume of the window breaker and increase the versatility of the key housing, as well as shorten the time required for the user to locate the window breaker and reduce the likelihood of misoperation, thereby improving the safety and portability of the window breaker.

### BRIEF DESCRIPTION OF THE DRAWINGS

FIG. 1 is an exploded structural view of a vehicle key housing according to an embodiment of the present disclosure;

FIG. 2 is a schematic view of the lower housing of a vehicle key housing according to an embodiment of the present disclosure;

FIG. 3 is an enlarged schematic view of the partial region A of FIG. 2; and

FIG. 4 is an exploded structural view of a vehicle key housing according to another embodiment of the present disclosure.

### DETAILED DESCRIPTION OF THE EMBODIMENTS

The accompanying drawings of the present disclosure are provided for illustrative purposes only and should not be construed as limiting the present disclosure. Some components may be omitted, enlarged, or reduced in the drawings for better illustration, but this does not represent the actual size of the product. For those skilled in the art, the description of certain well-known structures may be omitted.

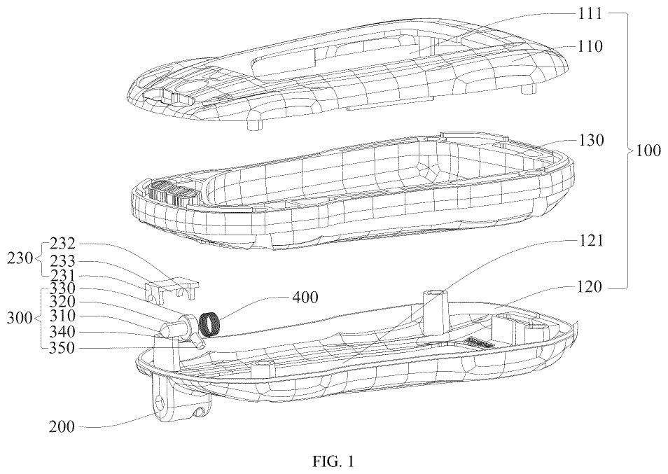

Referring to FIGS. 1-3, a vehicle key housing with a concealable window breaker is provided according to an embodiment of the present invention, including a key housing body 100, which is in a rigid structure entirely or at least partially. The rigid structure of the key housing body 100 forms an accommodating cavity 200 with an opening 210 facing the edge of the key housing body 100. The key housing further includes a window breaker 300 having a folded state and a use state. In the use state, a window breaking tip 310 of the window breaker 300 protrudes from the opening 210 and extends beyond the edge of the key housing body 100. In this state, the rigid structure of the key housing body 100 provides support for the window breaker 300. In the folded state, the window breaker 300 is folded within the accommodating cavity 200, with the window breaking tip 310 not extending beyond the edge of the key housing body 100.

In this embodiment, the rigid structure of the key housing body 100 provides stable support for the window breaker 300 in the use state, while the accommodating cavity 200 provides an isolation shield for the window breaker 300 in the folded state, preventing the window breaker 300 from scratching the human body or other components.

The key housing body 100 as a whole forms a grip structure with a long axis direction and a short axis direction, and the grip structure has two ends along the long axis direction, the dimension of one end of the key housing body 100 at the short axis direction is smaller than that at another end. The accommodating cavity 200 is located at the one end with smaller dimension, and the opening 210 faces the edge of that end. In this embodiment, the end of the key housing body 100 where the window breaker 300 is located has a smaller dimension at the short axis direction than the other end, and the opening 210 faces the edge of such end. This design allows users to determine the location of the window breaker 300 even without illumination by identifying the smaller dimension at the short axis direction, ensuring that the window breaker 300 can be promptly accessed in the use state, effectively enhancing the safety and convenience of the window breaker 300. Furthermore, during emergency window breaking, the long and short axis design of the key housing body 100 with grip structure can guide the user to apply hand force more effectively, improving the window breaking efficiency.

The outer surface of the key housing body 100 is a curved transitional surface or a combination of multiple curved transitional surfaces to facilitate hand gripping. In this embodiment, the curved transitional surface of the outer surface of the key housing body 100 enhances the fitness between the user's fingers and the key housing body, improving grip comfort. Additionally, the curved transitional surface in this embodiment resembles a sports car, such design can remind drivers of the window breaker 300 inside every time they use the key. When emergency window breaking is needed, users can locate the window breaker 300 in the shortest possible time and deploy it for emergency use.

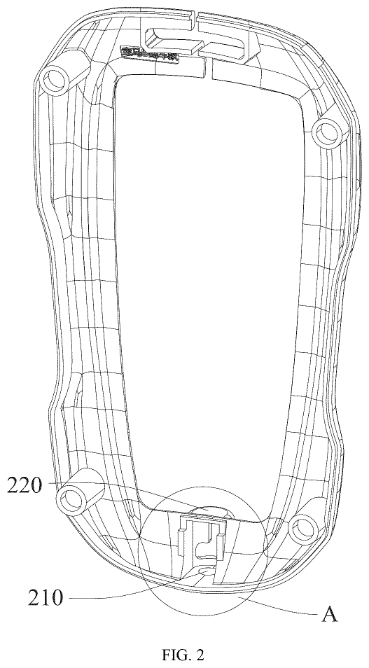

As shown in FIG. 2, the accommodating cavity 200 protrudes from the surface of the key housing body 100 according to an embodiment, forming a straight end surface 220 on the side opposite the opening 210. In this embodiment, one end of the accommodating cavity 200 is the opening 210, and the other end is the straight end surface 220. When the window breaker 300 is in the use state, the window breaking tip 310 protrudes from the opening 210, and the straight end surface 220 provides a support surface for the protrusion of the window breaking tip 310.

Referring back to FIG. 1, the key housing body 100 at least includes an upper housing 110 and a lower housing 120, which are engaged with each other by snap fitting. The accommodating cavity 200 is integrally formed with the lower housing 120 as a metal structure, and the lower housing 120 is provided on the inner side thereof with a cover plate 230 to enclose the accommodating cavity 200. In this embodiment, the lower housing 120 and the accommodating cavity 200 are integrally formed as a metal structure, providing a high-strength protective enclosure for the window breaker 300 in the folded state and preventing the window breaker 300 from accidentally ejecting from the accommodating cavity 200, thereby avoiding safety hazards to the driver. The cover plate 230 provides proper enclosure for the window breaker 300.

The upper housing 110 is also in a metal structure, and the upper housing 110, lower housing 120, and accommodating cavity 200 thus together form a rigid structure. The upper and lower housings are secured together with screws into an integrated structure. A button access window 111 is provided in the middle of the upper housing 110, and a weight reduction window 121 is provided in the middle of the lower housing 120. In this embodiment, the button access window 111 allows direct access to the buttons of the vehicle key, and since both the upper housing 110 and the lower housing 120 are metal structures, with the button access window 111 and the weight reduction window 121 occupying a relatively large area of the upper housing 110 and lower housing 120, respectively, the weight of the upper housing 110 and lower housing 120 can be effectively reduced, ensuring that the weight increase of the key housing after incorporating the window breaker 300 is not significant, thereby enhancing the flexibility of the key housing. The upper housing 110 and the lower housing 120 are secured together with screws, as well as increasing the stability of the key housing.

Preferably, the key housing body 100 further includes a middle housing 130 sandwiched between the upper housing 110 and the lower housing 120, wherein the middle housing 130 is made of a flexible material, forming an annular flexible surface along the snap-fitting area of the upper and lower housings. In this embodiment, the middle housing 130 is made of silicone material and is used to hold the vehicle key. The vehicle key is thus placed between the upper housing 110 and the lower housing 120, and secured by tightening the fixing screws. Additionally, the middle housing 130 provides cushioning and sealing between the upper housing 110 and the lower housing 120, preventing the impact force of the window breaker 300 from affecting the use of the vehicle key. The annular flexible surface also increases friction for the user, preventing detachment of the window breaker 300 during use.

The accommodating cavity 200 has an axial internal space with dimensions larger than the entire window breaker 300. The opening 210 is formed at the front end of the axial internal space, and the rear end thereof is closed. An elastic mechanism 400 is arranged between the rear end and the window breaker 300. The elastic mechanism 400 is configured to support the window breaker 300 to make the window breaking tip 310 protruding from the opening 210. In this embodiment, the window breaking tip 310 and the elastic mechanism 400 are arranged in the accommodating cavity 200 in front and rear positions, respectively. Due to the elastic deformation of the elastic mechanism 400, the window breaking tip 310 can extend or retract through the opening 210.

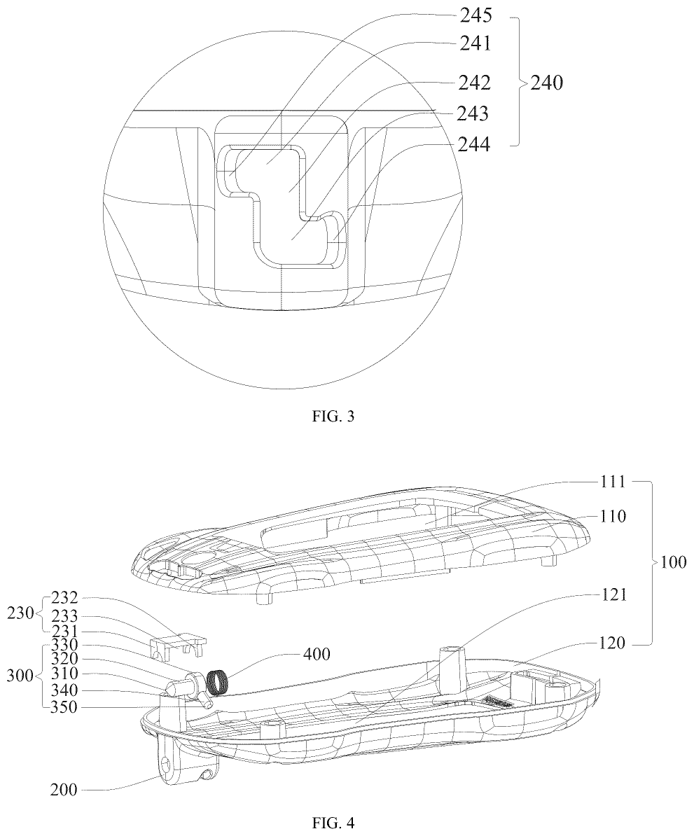

The window breaker 300 specifically includes a sliding cylinder 320, a limiting cylinder 330, and an actuation handle 340. The window breaking tip 310 is formed at the front end of the sliding cylinder 320. The limiting cylinder 330, with a larger diameter than the sliding cylinder 320, is coaxially arranged at the rear end of the sliding cylinder 320. The actuation handle 340 is connected to the side of the limiting cylinder 330 and extends radially. A sliding groove 240 (shown in FIG. 3) is formed on the accommodating cavity 200, and the actuation handle 340 is slidable within the sliding groove 240, enabling the window breaker 300 to switch between the folded state and the use state.

With reference to FIG. 3, in this embodiment, when the window breaker 300 is in the folded state, the window breaking tip 310 is concealable and not exposed. At this time, the actuation handle 340 is positioned within the reset aperture 245. When the window breaker 300 is in the use state, the actuation handle 340 is slid to the middle of the sliding groove 240, and the window breaking tip 310, under the pressure of the rear elastic mechanism 400, naturally protrudes and slides out until the window breaking tip 310 stops protruding beyond the opening 210. At this point, the actuation handle 340 is further slid into the limiting recess 244 to prevent the window breaking tip 310 from retracting during the force application process.

The sliding groove 240 has an overall Z-shape, including an upper horizontal groove 241, a connecting groove 242, and a lower horizontal groove 243. A limiting recess 244 for engaging the actuation handle 340 is provided at the end of the upper horizontal groove 241 away from the window breaking tip 310. A protruding reset flange 350 is arranged at the rear end of the limiting cylinder 330. The accommodating cavity 200 is provided with a front support 231 and a rear support 232, with the front support 231 having a supporting aperture 233 for the sliding motion of the sliding cylinder 320, and the rear support 232 having a reset aperture 245 for engaging the reset flange 350. In this embodiment, the front support 231 and the rear support 232 form the mounting base for the cover plate 230. The upper horizontal groove 241, connecting groove 242, and lower horizontal groove 243 form the supporting framework for the sliding groove 240. The reset flange 350 facilitates manual actuation by the user.

As shown in FIG. 4, the key housing body 100 only includes an upper housing 110 and a lower housing 120, without a middle housing 130, according to another embodiment. In this case, the vehicle key can be directly fixed on either the upper housing 110 or the lower housing 120, with the fixing position of the vehicle key isolated from the mounting position of the window breaker 300, preventing interference with the normal use of the vehicle key during the operation of the window breaker 300.

It should be noted that the above embodiments are merely examples provided for the purpose of clearly illustrating the technical solutions of the present disclosure and should not be construed as limiting the specific implementations of the present disclosure. Any modifications, equivalent substitutions, and improvements made within the spirit and principles of the present disclosure should be included in the scope of protection of claims of the present disclosure.

What is claimed is:

1. A vehicle key housing with a concealable window breaker, comprising:
a key housing body, wherein the key housing body is in a rigid structure entirely or at least partially, and the rigid structure forms an accommodating cavity, the accommodating cavity having an opening facing an edge of the key housing body, and
a window breaker, the window breaker having a folded state and a use state;
wherein in the use state, a window breaking tip of the window breaker protrudes from the opening and extends beyond the edge of the key housing body, and in this state, the rigid structure of the key housing body provides support for the window breaker; and
in the folded state, the window breaker is folded within the accommodating cavity, with the window breaking tip not extending beyond the edge of the key housing body.

2. The vehicle key housing according to claim 1, wherein the key housing body as a whole forms a grip structure, having a long axis direction and a short axis direction, wherein the key housing body has two ends along the long axis direction, a dimension of one end of the key housing body at the short axis direction is smaller than that at another end, the accommodating cavity is located at the one end with smaller dimension, and the opening faces the edge of the one end.

3. The vehicle key housing according to claim 2, wherein an outer surface of the key housing body is a curved transitional surface or a combination of multiple curved transitional surfaces to facilitate hand gripping.

4. The vehicle key housing according to claim 2, wherein the accommodating cavity protrudes from an outer surface of the key housing body, forming a straight end surface on a side opposite the opening.

5. The vehicle key housing according to claim 1, wherein the key housing body is in a snap-fitting structure at least comprising an upper housing and a lower housing, the accommodating cavity is integrally formed with the lower housing as a metal structure, and the lower housing is provided on the inner side thereof with a cover plate for enclosing the accommodating cavity.

6. The vehicle key housing according to claim 5, wherein the upper housing is also in a metal structure, the upper housing, the lower housing, and the accommodating cavity together form the rigid structure, the upper housing and the lower housing are secured together with connectors into an integrated structure, a button access window is provided in the middle of the upper housing, and a weight reduction window is provided in the middle of the lower housing.

7. The vehicle key housing according to claim 5, wherein the key housing body further comprises a middle housing sandwiched between the upper housing and the lower housing, wherein the middle housing is made of a flexible material, forming an annular flexible surface along a snap-fitting area of the upper housing and the lower housing.

8. The vehicle key housing according to claim 1, wherein the accommodating cavity has an axial internal space, the axial internal space has a dimension larger than the entire window breaker, the opening is formed at a front end of the axial internal space, a rear end of the axial internal space is closed, and an elastic mechanism is arranged between the rear end and the window breaker, the elastic mechanism supporting the window breaker and causing the window breaking tip to protrude from the opening.

9. The vehicle key housing according to claim 8, wherein the window breaker comprises a sliding cylinder, a limiting cylinder, and an actuation handle, the window breaking tip is formed at a front end of the sliding cylinder, the limiting cylinder has a larger diameter than the sliding cylinder and is coaxially arranged at a rear end of the sliding cylinder, the actuation handle is connected to a side of the limiting cylinder and extends radially, a sliding groove is formed in a sidewall of the accommodating cavity, and the actuation handle is slidable within the sliding groove to switch the window breaker between the folded state and the use state.

10. The vehicle key housing according to claim 9, wherein the sliding groove has an overall Z-shape, comprising an upper horizontal groove, a connecting groove, and a lower horizontal groove, a limiting recess for engaging the actuation handle is provided at an end of the upper horizontal groove away from the window breaking tip, a protruding reset flange is arranged at a rear end of the limiting cylinder, the accommodating cavity is provided with a front support and a rear support, the front support is provided with a supporting aperture for the sliding motion of the sliding cylinder, and the rear support is provided with a reset aperture for engaging the reset flange.
